(19) United States
(12) Patent Application Publication
(10) Pub. No.: US 2017/0212951 A1
(43) Pub. Date: Jul. 27, 2017

(54) CALCULATED RELATIONSHIPS IN DOCUMENT FLOW

(71) Applicant: SAP SE, Walldorf (DE)

(72) Inventor: Rudolf WENZLER, Besigheim (DE)

(21) Appl. No.: 15/007,900

(22) Filed: Jan. 27, 2016

(51) Int. Cl. G06F 17/30

(52) U.S. Cl. CPC G06F 17/30598; G06F 17/30011; G06F 17/30589; G06F 17/30327

(57) ABSTRACT

A computer-implemented method determines a document flow of documents stored in a documents database. Data on the documents including relational data may be stored in the documents database. The method includes creating a database view of the document flow of the documents stored in the documents database. Creating the database view of the document flow includes calculating a document-document relationship on the fly by retrieving references from the original documents stored in the documents database. A SQL select statement is used to calculate the document-document relationship.

### BACKGROUND

Computer systems can run computer programs to perform various business functions. These applications (e.g., applications for customer relationship management, human resource management, outsourcing relationship management, field service management, enterprise resource planning (ERP), enterprise content management (ECM), business process management (BPM), product lifecycle management, etc.) may be used to increase productivity, to measure productivity and to perform the business functions accurately.

An aspect of the applications is the large amounts of data or documents that can be used or generated for each business function in a business process. The documents may contain a large number of document types (e.g., orders, shipping documents, invoices, goods movements, etc.). The data or documents may be stored in a database (e.g., a relational database) and queried, analyzed or further processed by the business applications. The stored documents may be linked together and integrated to provide data integration and end-to-end business data visibility at all points of the business process. Relational data (e.g., document flow or history) describing the relations between various documents may be stored in the relational database.

For example, in the case of sales-related business transactions, individual transactions (e.g., inquiry, quotation, sales order, shipment, invoice, and returns, etc.) may be stored as individual sales documents (SD) in a “documents” database. The relational data (so-called document flow or history) linking various individual documents may be stored in a database table (e.g., table VBFA) linking various individual documents. An entire chain of sales documents (e.g., inquiry, quotation, sales order, shipment, invoice, and returns, etc.) may create a document flow or history. In such case, the stored relational data may include direct relations between individual documents (e.g., “order leading to shipment,” “shipment leading to invoice,” etc.). In some scenarios, storing the relational data including the direct relations may require considerable storage and can be burdensome.

Formally, a “database” refers to a set of related data and the way it is organized. Access to this data can provided by a “database management system” (DBMS) consisting of an integrated set of computer software that allows users to interact with one or more databases and provides access to all of the data contained in the databases. The DBMS can provide various functions that allow entry, storage and retrieval of large quantities of information and provides ways to manage how that information is organized.

Consideration is now being given to data models, and systems and methods for determining “document flow,” for example, for consumption by business applications.

### SUMMARY

Data on documents is stored in a documents database (e.g., a relational database) according to a hierarchical model to facilitate determination of documents flows, which may be consumed, for example, by business applications. Systems and methods for determining a document flow of documents stored in a documents database are described herein.

In a general aspect, a computer-implemented method includes assigning a hierarchical tree-like structure to the documents stored in the documents database. Each hierarchy level in the tree-like structure corresponding to a direct document-document relationship between the documents assigned to the nodes of the hierarchy level. The method further includes creating a database view of a document flow of the documents stored in the documents database.

In an aspect, creating the database view of the document flow includes calculating a document-document relationship on the fly by retrieving references from the original documents. Calculating the document-document relationship on the fly includes using an SQL select statement to calculate the document-document relationship.

In a further aspect, the database view of the document flow, in addition to predecessor and successor information for documents includes information for a number of additional attributes of the document-document relationship, and creating the database view of the document flow includes calculating information on attributes of the document-document relationship on the fly. Calculating information on attributes of the document-document relationship on the fly includes calculating information on attributes in a declarative manner based on rules for customizing information or data stored within the original documents.

In a yet further aspect, creating the database view of the document flow includes individually retrieving document-document relationships that cannot be calculated in a declarative manner from the documents database.

In another aspect, creating the database view of the document flow includes representing each of multiple levels of a document-document relationship hierarchy in the documents database with distinct database views.

In yet another aspect, creating the database view of the document flow includes grouping different document types in generic semantical document groups, and, for each document type tuple (preceding group, succeeding group), using a same set of attributes as a reference to calculate a relationship between any two documents in the tuple. Creating the database view of the document flow includes, for one or more document type tuple (preceding group, succeeding group) representing all of the calculated document relationships as a single distinct database view. Further, creating the database view of the document flow can include, for all document type tuples for which the document relationships are not calculated, supplementing the calculated relationships represented in the single database view with a database table storing the uncalculated document relationships.

The details of one or more implementations are set forth in the accompanying drawings and the description below. Further features of the disclosed subject matter, its nature and various advantages will be more apparent from the accompanying drawings, the following detailed description, and the claims.

### BRIEF DESCRIPTION OF THE DRAWINGS

FIG. 1 is an illustration of an example hierarchical tree-like structure that may be assigned by a hierarchical data model to sales transactions data, in accordance with the principles of the present disclosure.

FIG. 2 is a tabular representation of a 2-hierarchy level tree-like structure model of a document flow, in accordance with the principles of the present disclosure.

FIG. 3 is a schematic block diagram illustrating an example database management system, which is configured to provide a view-based representation of document flow, in accordance with the principles of the present disclosure.

FIG. 4 is an example table listing commonly available document types (e.g., types A, B, C. etc., which may be listed under document category field “VBTYP” of table VBFA) in the example use case involving sales transactions data.

FIG. 5 is an example table listing row-by-row the various relationships that may occur between the various documents types listed in FIG. 4.

FIG. 6 is a schematic block diagram showing a structure of an example database view of a document flow, in accordance with the principles of the present disclosure.

FIG. 7 includes illustrative screenshots of test measurements of creating a database view of a document flow, in accordance with the principles of the present disclosure.

FIG. 8 illustrates an example computer-implemented method for determining a document flow of documents (e.g., business transactions documents) stored in a documents database, in accordance with the principles of the present disclosure.

### DETAILED DESCRIPTION

A hierarchical data model may be used to assign a hierarchical tree-like structure to relational “business transactions data” or “documents” data that may be consumed by a business application or may be stored in a database. Beginning with a root node object, each branch (or sub branch) of the tree-like structure may represent a direct object-object relation in the data. The hierarchical tree-like structure may include several levels of hierarchy with each level defined by the direct relations between the pairs of tree nodes/objects in the level.

For convenience in description herein, the terms “database”, “table” and “database table” may be used interchangeably herein. The terms “business transactions data” and “documents” may be used interchangeably herein. Further, the term “database” may be used to interchangeably refer to both a database and a database management system (DBMS) that may be used to manipulate the database.

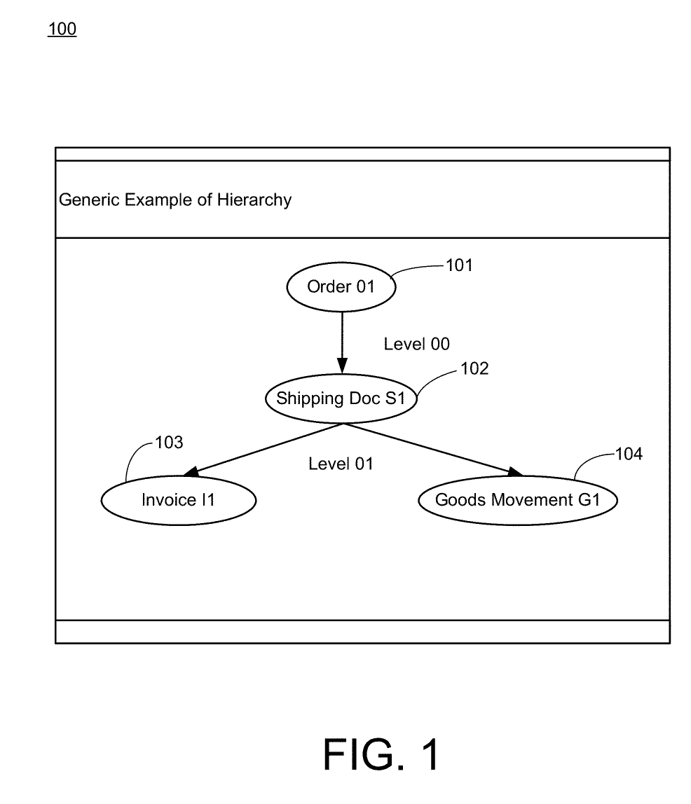

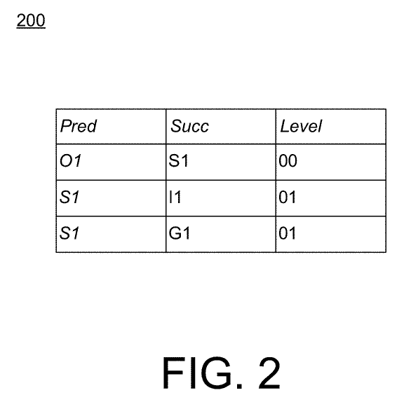

FIG. 1 shows, for example, a hierarchical tree-like structure that may be assigned by the hierarchical data model to the data in a use case involving sales transactions data. The sales transactions data may include objects or documents such as orders, shipping documents, invoices, goods movements, etc., which may be stored in “document” databases by a sales organization. The documents may be individual documents, but they can also form part of a chain of inter-related documents. For example, an “inquiry” document may be a record of a customer's telephone inquiry for goods. The customer may request a quotation, which is created by referring to the inquiry. The customer may later place an order by referring to the quotation. Sales personnel may create a sales “order” with reference to the quotation, ship the goods and invoice the customer. After delivery of the goods, the customer may claim credit for some damaged goods, for which the sales personnel may create a “free-of-charge delivery” document with reference to the sales order. The entire chain of documents—the inquiry, the quotation, the sales order, the delivery, the invoice, and the subsequent free-of-charge delivery document creates a document flow or history. These documents may relate to each other as predecessor and successor in the document flow. For example, an order document (predecessor) may lead to a shipment document (successor). The shipment document (predecessor) may lead to an invoice document (successor) and/or a goods movement documents (successor). Computerized or automated flow of data from one document into another may reduce manual activity and make problem resolution easier. Business computing systems may store document flow information in a designated database or table. For example, in database management systems (DBMS) provided by assignee SAP, table VBFA is a standard SAP Table which is used to store sales document flow information.

FIG. 1 schematically shows a 2-heirachy level tree-like structure model representation 100 of the document flow in the foregoing example. In tree-like structure model representation 100, document 101 (e.g., order O1) is the root node of the tree-like structure and document 102 (e.g., shipping document S1) is a successor object to the root node object. The predecessor-successor relationship between root node (document 101) of the tree-like structure and document 102 may define a first level of the hierarchy starting from the root node. Document 102 (e.g., shipping document S1) has predecessor-successor relationships with document 103 (e.g., invoice document I1) and document 104 (e.g., goods movement document G1). These predecessor-successor relationships may define a second level of the hierarchy starting from the root node. (For convenience, the first level and the second level of the hierarchy are visually labeled in FIG. 1 as “Level 00” and “Level 01,” respectively).

FIG. 2 shows an example database table 200 representing the 2-hierarchy level tree-like structure 100 of a document flow. Table 200 may be assembled (e.g., by the DBMS) using, for example, Advanced Business Application Programming (ABAP) language and SQL commands. Table 200 may be made available to users as an ABAP consumable. As shown in FIG. 2, table 200 may include three rows—a first row indicating that order document O1 and shipping document S1 are directly related as predecessor (pred) and successor (succ) objects in hierarchy level 00, a second row indicating shipping document S1 and invoice document I1 are directly related as predecessor and successor objects in hierarchy level 01, and further a third row indicating shipping document S1 and goods movement document G1 (I1) are also directly related as predecessor and successor objects in hierarchy level 01.

Only direct document-document relations may be used or necessary for assembling a tabular representation of the document flow. The tabular representation may be a virtual table or consumable provided to a consuming business application. Example implementations of such a documents database (e.g., database table 200, FIG. 2), which stores only direct document-document relations, are described, for example, in Wenzler U.S. patent application Ser. No. 14/692,029. Storing (e.g., in table VBFA) only the direct document-document relations may enable fast look-up to identify preceding and succeeding documents and at the same time avoid the computational expense of having to otherwise independently access and analyze a large number of database tables for references to identify potential document-document relations.

Storing only the direct document-document relations of the hierarchy (e.g., FIG. 1) also reduces storage requirements for the database (e.g., table 200) by eliminating storage requirements for storing additional data (e.g., data on indirect relationships). However, for an organization or business with a large number of transactions, persistently storing even only the direct document-document relations may still require considerable storage.

It is noted that the relational information (e.g., predecessor, successor information) captured in the direct document-document relations (i.e., edges) of the hierarchy stored in the database (e.g., table 200) may also be present as reference information contained in the original documents (e.g., order document O1, shipping document S1, goods movement document G1, etc.). For example, shipping document S1 may include reference information identifying or pointing to the order document O1 as the basis or cause for the goods shipments described by shipping document S1. Thus, the relational information may be redundantly present as the direct document-document relations explicitly stored in the database (e.g., table 200) and as reference information in the original documents.

Database management systems (DBMS) and methods (collectively “solutions”) for determining “document flow,” (e.g., for consumption by business applications) are described herein, in accordance with the principles of the present disclosure. The solutions may involve utilizing database views to avoid storing the direct document-document relations in a database table, and yet avoid the computational expense or effort of having to otherwise independently access and scan a large number of documents for potential reference information on document-document relations. The solutions may involve obtaining a “document flow” database view (i.e. a virtual table based on the dynamic results returned in response to an SQL select statement) representing a combined view of all hierarchal relationships of the documents at once. To obtain the document flow database view, it may not be necessary to have the document-document hierarchy persistently stored in a database table (e.g., table 200 or table VBFA). The document-document hierarchy or relationships for the database view may instead be calculated on the fly (e.g., by the consuming business application or DBMS) by retrieving the corresponding references from the original documents. The solutions described herein to create a document flow database view may be compatible with a legacy installation of a table VBFA, but could render storage of some or all of the document-document relationships in the legacy installation of table VBFA redundant or obsolete.

In example implementations, the document flow view may also include information on attributes of the document-document relationships, which may be stored with the documents stored in a database. Like the document-document relationships, the attributes information for at least some attributes may also be calculated on the fly while retrieving the corresponding references from the original documents for identifying the document-document relationships.

In example implementations, the information on attributes may, in general, be calculated in a declarative manner, based, for example, on rules for customizing information or data stored within the original documents. However, in specific instances, there may be exceptions to the rules for customizing information or data stored within the original documents. The exceptions to the rules may preclude calculation of some data or information in a declarative manner on the fly. It will be noted that attribute information, which cannot be calculated on the fly may have to be persistently stored. Such attribute information which cannot be calculated on the fly may be provided in a traditional manner (e.g., stored in a VBFA record in addition to the predecessor and successor information) to users.

As an example of the exceptions, which preclude calculation of some data or information in a declarative manner, for some databases or systems, specific coding in ABAP can be used to override the rules for customizing information or data stored in the original documents in document databases. For example, an original document (an invoice) may include a “restocking” indicator attribute, a coded value of which may overrule a calculated relationship with a warehouse inventory document (e.g., an indicator attribute value “Type A” or “Type B” corresponding to whether the stock in the warehouse should be increased or decreased). If such specific types of document relationships are involved in document flow, it may be necessary to explicitly store the specific predecessor and successor document relationships in the database to be able to determine the complete “document flow.” Thus, it may be possible to have specific data or information, contradicting the general rules, for distinct edges (e.g., a specific predecessor—successor tuple) stored in document databases. This specific data or information may have to be individually retrieved instead being calculated in a declarative manner.

There can be other example scenarios in which it may not be possible to calculate document relationship in a declarative manner. In a first example scenario, it may not be possible to calculate a predecessor-successor relationship because the predecessor and successor documents are not stored in the same system. In a second example scenario, a predecessor-successor relationship between a pair of documents may contain additional attributes that cannot be calculated in a declarative manner, but require imperative application logic for calculation. In either example scenarios, since the relationships cannot be calculated on the fly in a declarative manner, the relationships for the predecessor—successor tuples must be persistently stored determining document flow.

The solutions for determining document flow described herein may provide a view-based representation of the document flow, which includes document-document relationships that are subject to the foregoing exceptions. Thus, the complexity caused by the presence of the rule-exceptions can be shielded from the consuming SQL/business application.

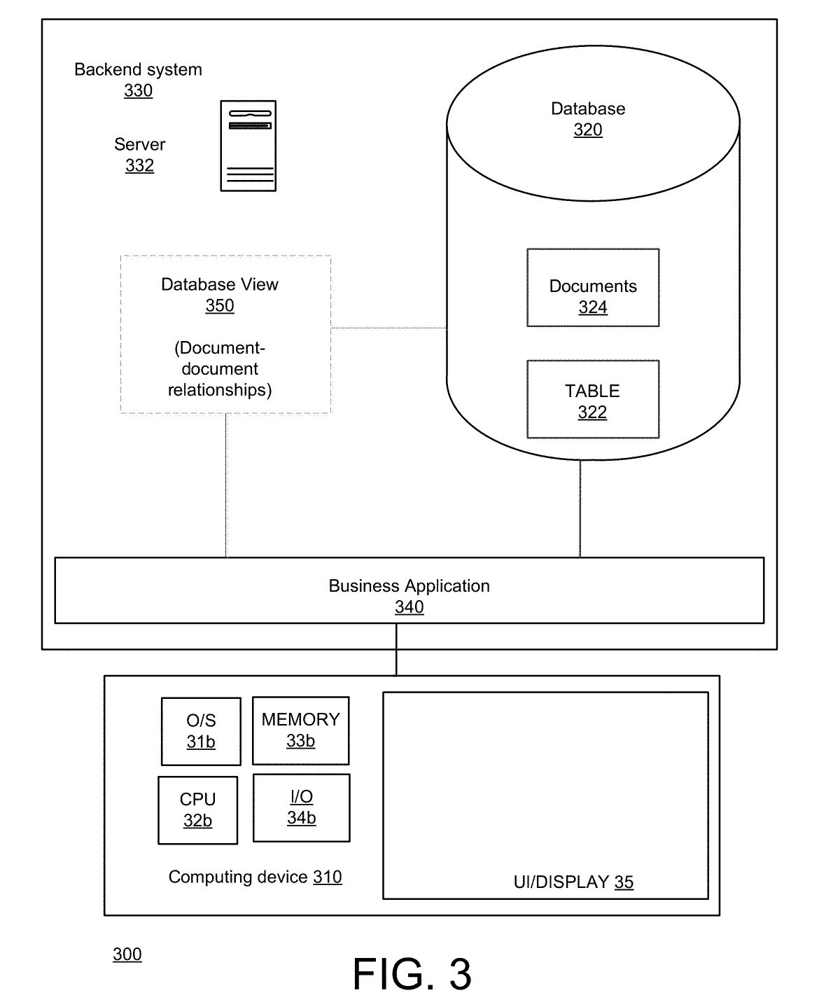

FIG. 3 is a schematic block diagram showing an example database management system 300, which includes a relational database 320, and is configured to provide a view-based representation of the document flow, in accordance with the principles of the present disclosure.

System 300 may include a business application 340 coupled to relational database 320. Business application 340 may generate or manipulate business transactions data (e.g., documents 324 concerning sales transactions, table 322, etc.) stored in relational database 320. Business application 340 may consume a view-based representation of document flow (e.g., database view 350) of documents 324 provided by system 300 to facilitate, for example, a flow of data amongst the manipulated documents.

Business application 340 may, for example, be hosted or launched on a computer 310. Computer 310, which includes an O/S 31b, a CPU 32b, a memory 33b, and I/O 34b, may further include a user interface (UI) or display 35. Although computer 310 is illustrated in the example of FIG. 3 as a single computer, it may be understood that computer 310 may represent two or more computers in communication with one another. Therefore, it will also be appreciated that any two or more components 320-350 of system 300 may similarly be executed using some or all of the two or more computers in communication with one another. Conversely, it also may be appreciated that various components illustrated as being external to computer 310 may actually be implemented therewith. In an example scenario, business application 340 may be an application, which can run on computer 310 or, for example, in another computing environment (e.g., backend system 330/server 332).

An example of view-based representation of document flow 350, as described herein, in addition to pred and succ information for documents may include a number of additional attributes for various business related information.

For purposes of illustration, DBMS 300 and database 320, which may be SQL-based systems, may be described in the context of a use case involving sales transactions data. The example view-based representation of document flow 350 may be rendered using, for example, ANSI-SQL compatible declarations. Further, the example view-based representation of document flow 350 may be described herein with reference to fields of table VBFA (e.g., table 322), which is a standard SAP table used to store sales document flow information. The example view-based representation may be described herein using the following VBFA definitions or terminology for predecessor and successor documents:

Predecessor: Document ID (attribute VBELV); Item number (attribute POSNV); Document type (attribute VBTYP_V)

Successor: Document ID (attribute VBELN); Item number (attribute POSNN); Document type (attribute VBTYP_N)

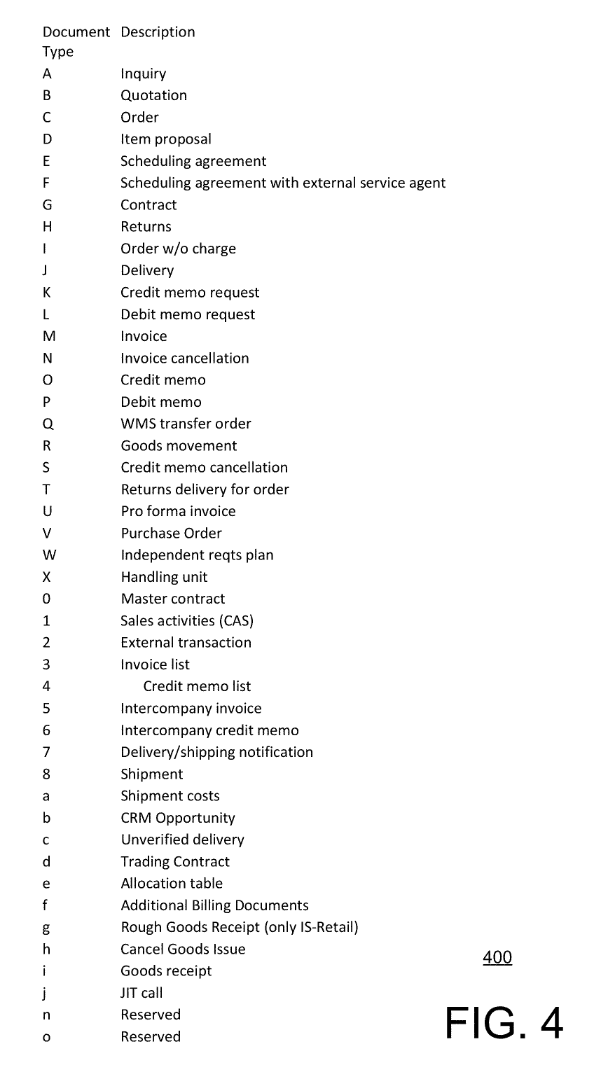

In an illustrative example, the predecessor and successor documents may include a large number of different document types. Each document having a specific document type may be related to another document having another specific document type. For example, documents of document type “order” may relate to documents of document type “delivery” as a predecessor; documents of document type order may relate documents of document type invoice as a predecessor; documents of document type delivery may relate to documents of document type invoice as a predecessor. FIG. 4 shows an example table 400 listing commonly available document types (e.g., types A, B, C. etc., which may be listed under document category field “VBTYP” of table VBFA) in the example use case involving sales transactions data.

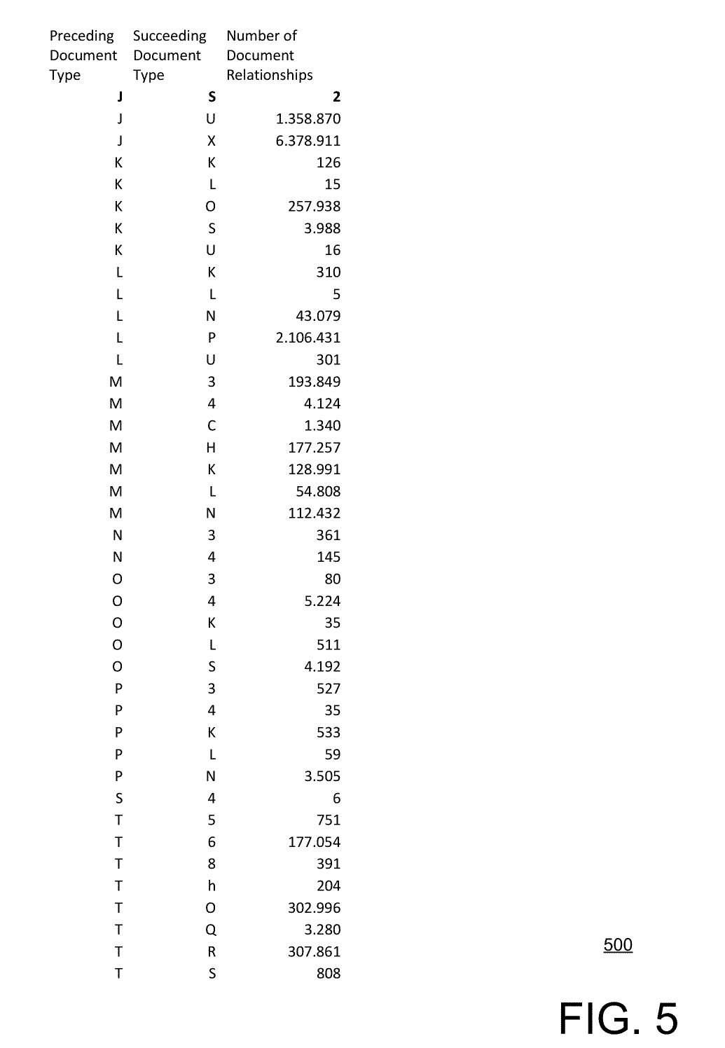

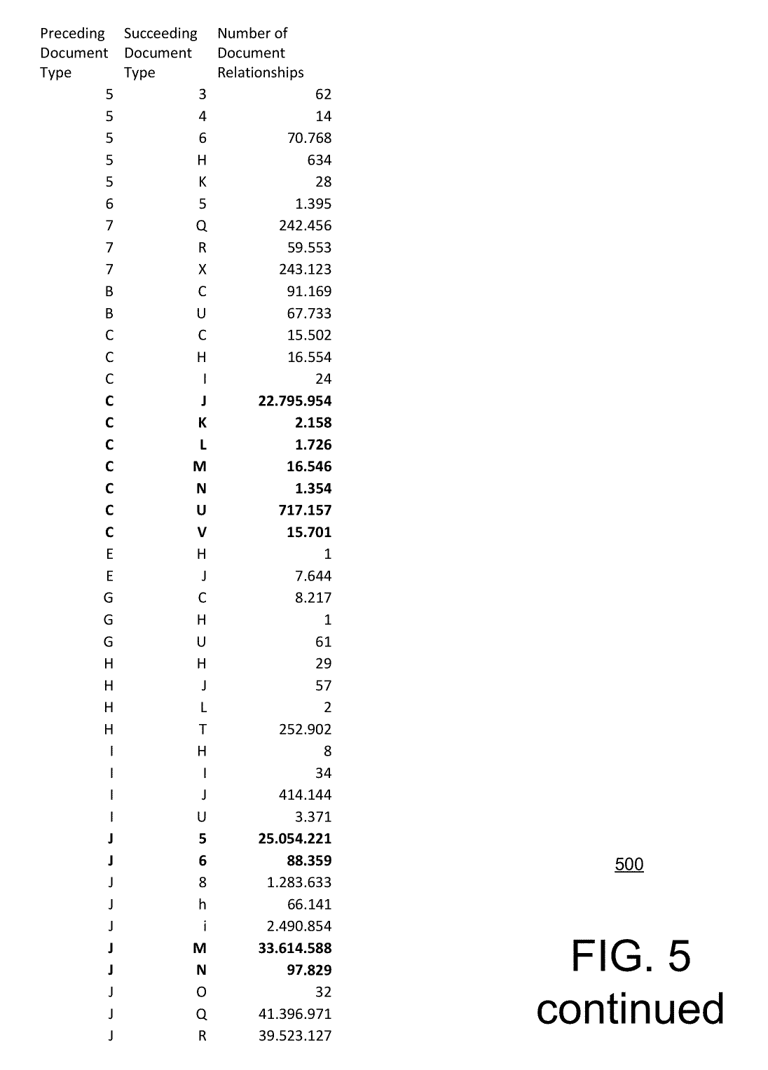

Depending on the configured functionality of the use case, various relationships between the various document types may occur. FIG. 5 shows an example table 500 listing row-by-row the various relationships that may occur between the various documents types listed in FIG. 4. For example, table 500, in a first row under a first column heading “Preceding Document Types” and a second column heading “Succeeding Document Types, shows a predecessor-successor relationship of document type “5” and document type “3.” Under a third column heading “Number of Document Relationships,” table 500 shows a numerical count of the instances of each predecessor-successor relationship that were found in an example instance of the use case involving sales transactions data. For example, table 500 shows in the first row under the third column heading “Number of Document Relationships” that 62 instances of predecessor-successor relationship of document type “5” and document type “3” (first row) were found in the example instance of the use case involving sales transactions data.

In FIG. 5, the numerical values in the third column of table 500 are shown in either regular font or in bold font. The numerical values, whether shown in regular font or bold font, correspond to how many document relationships (e.g., equaling rows in table VBFA) for the corresponding tuple (preceding-document-type, succeeding-document-type) were present in the example instance of the use case involving sales transactions data. However, the regular font for a numerical value indicates that corresponding document relationship was explicitly stored in database 320 (e.g., as rows in table VBFA, or table 322). In contrast, the bold font for a numerical value indicates that corresponding document relationship was calculated on the fly instead of being stored in or retrieved from database 320/table VBFA.

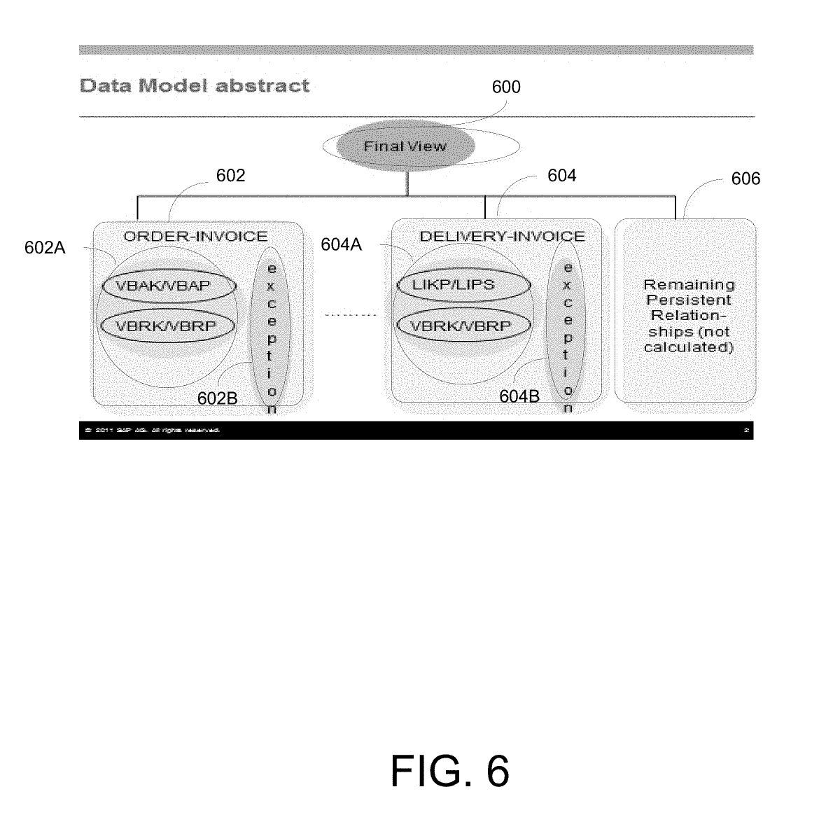

With renewed reference to FIG. 3, in example implementations of DBMS 300, the document relationships in a document flow, including multiple levels of the document-document relationship hierarchy in the documents database, may be represented by distinct database views. The overall structure of the representation of the document relationships as a database view (e.g., database view 350 (FIG. 3), database view 600 (FIG. 6)) may include grouping of document types in generic semantical document groups, with the original documents for each of these groups stored in the same respective database tables. For each document type tuple (preceding group, succeeding group), the same attributes may be used as a reference to calculate or establish the relationship or link between any two documents in the tuple.

For example, with reference to the example use case involving sales transactions data, the documents types shown in table 400 and 500 (FIGS. 4 and 5) may be grouped in generic semantical document type groups “ORDER, “INVOICE” and “DELIVERY.” Group ORDER may include document types ‘C’, ‘H’, and ‘I’; group INVOICE may include document types ‘K’, ‘L’, ‘M’, ‘N’, ‘U’, ‘5’, and ‘6’; and group DELIVERY may include document types ‘J’, and ‘Z’. The original documents for each of these groups may be stored in the same respective database tables. For example, the original documents for group ORDER may be stored in a database table with VBAK (header) and VBAP (item); the original documents for group INVOICE may be stored in VBRK (header) and VBRP (item); and the original documents for group DELIVERY may be stored in LIKP (header) and LIPS (item). For each tuple of (preceding group, succeeding group) the same attributes (e.g., table:field) may be used as a reference to calculate or establish the relationship or link between two documents. For example, the link between ORDER documents and INVOICE documents may be calculated or established via attributes vbrp.mandt=vbap.mandt, and vbrp.vgbel=vbap.vbeln, and vbrp.vgpos=vbap.posnr. The link between ORDER documents and DELIVERY documents may be determined via attributes lips.mandt=vbap.mandt, and lips.vgbel=vbap.vbeln, and lips.vgpos=vbap.posnr. Further, the link between DELIVERY documents and INVOICE documents may be determined via vbrp.mandt=lips.mandt, and vbrp.vgbel=lips.vbeln, and vbrp.vgpos=lipsp.posnr. For each document type tuple (preceding group, succeeding group), additional attributes may be calculated similarly.

For each document type tuple (preceding group, succeeding group) all of the calculated or determined document relationships may be represented by a single database view, in accordance with the principles of the present disclosure. Further, for each original document, a specific exception could be stored in a separate database table. The specific exception may override any calculated relationship (specifically the values of the additional attributes) of the document. Additionally, for all document type tuples for which the document relationships cannot be calculated, a database table storing these document relationships may be created or maintained (e.g., table VBFA) to supplement the calculated relationships represented in the single database view.

FIG. 6 is a schematic block diagram showing a structure of an example database view 600 of a document flow, in accordance with the principles of the present disclosure.

Database view 600 of the document flow, as shown in the figure, may include distinct database views of document relationships for different document type groups. For example, database view 600 may include distinct database views 602 and 604 for group Order-Invoice and group Delivery-Invoice, respectively. Database view 600 may also include a database view for group Order-Delivery (not shown). Each database view for a document type group (e.g., database views 602 and 604) may include calculated document-document relationships (which are calculated using open SQL queries) and also document-document relationships that are rule-exceptions to calculated values. For example, database view 602 for the group Order-Invoice includes calculated document-document relationships 602A (e.g., VBAK/VBAP and VBRK/VBRP), and calculation exceptions 602B. Similarly, database view 604 for the group Delivery-Invoice includes calculated document-document relationships 604A (e.g., LIKP/LIPS and VBRK/VBRP), and calculation exceptions 604B.

Database view 600 of the document flow, in addition to the distinct database views (e.g., database views 602 and 604) based on calculated relationships and calculation exceptions for document type groups, may also include “remaining persistent” document relationships 606, which are not calculated from references in the documents but may be persistently stored in database tables (e.g., table VBFA, table 322). In the foregoing example, remaining persistent document relationships 606, which are not calculated, may include document types other than group Order-Invoice 602, group Order-Delivery and group Delivery-Invoice 604. With reference to FIG. 5, remaining persistent document relationships 606 may correspond to the document relationships for which the numerical value in the third column of table 500 is marked in regular font indicating that corresponding document relationship were explicitly stored in database 320

The solutions for determining document flow described herein provide a view-based representation of the document flow, for example, as described above. A single database view (e.g., database view 600) may provide information on a complete set of document relationships present in the use case. In this aspect of providing information on the complete set of document relationships, the solutions for determining document flow described herein involving database views may be similar in capability to current techniques for determining document flow that rely on the information on the complete set of the variety of document relationships being persistently stored in table VBFA.

### Database Artifacts

Implementations of the view-based representation of the document flow (e.g., database view 600) may involve a multiple level composition (e.g., database view 602, database view 604, and remaining persistent document relationships 606) of the original documents information stored in database 320.

For an example use case involving SAP sales documents, the following terminology may be used for the original document tables:
VBAK—Sales Document: Header Data
VBAP—Sales Document: Item Data
VBRK—Billing Document: Header Data,
VBRP—Billing Document: Item Data
LIKP—Delivery Document: Header Data
LIPS—Delivery Document: Item Data

To construct or assemble database view 602 corresponding to document type group Order-Invoice, tables VBAK/VBAP and VBRK/VBRP may be joined via the join condition:
vbrp.mandt=vbap.mandt
and vbrp.vgbel=vbap.vbeln
and vbrp.vgpos=vbap.posnr,
   which may retrieve all Invoice documents directly related to an Order document. (These Order-Invoice documents relationships are represented by circle 602A in FIG. 6).

For each of these relationships an exception table may be left-outer joined to retrieve any existing exceptions for the same relationship key defined by:
pred-vbeln(→order-vbeln)=succ-vbeln(→invoice-vbeln)
pred-posnr(→order-posnr)=succ-posnr(→invoice-posnr)
pred-vbtyp(→order-doc-type)=succ-vbtyp(→invoice-doc-type).

The attribute list of the result set may be defined by having exceptions overriding the calculated values using, for example, the SQL-function coalesce. For example, for attribute volum having exceptions overriding the calculated values may involve storing the volume coalesce (exception-volum, calculated-volum) as volum. The exceptions result set is shown as exceptions 602B in FIG. 6.

The foregoing algorithms involving join and left-outer join operations may be similarly used to retrieve data to construct database views for all other document type tuples (e.g., database view 604 corresponding to document type group Delivery-Invoice, etc.).

Further, constructing or assembling remaining persistent document relationships 606 in database view 600, may simply involve selecting a physical database table (e.g., table VBFA) containing the data (i.e. the remaining persistent document relationships) and retrieving the data from the selected database.

The distinct individual views (e.g., database view 602, database view 604, and remaining persistent document relationships 606, etc.) may combined in database view 600 using a declaration union all to make a result set for the final view. Thus, database view 600 may represent all direct document-document relationships (e.g., in database 320) to a consuming SQL select query.

Accesses to the different distinct views (e.g., database view 602, database view 604, and remaining persistent document relationships 606, etc.) may be executed in most instances in parallel.

An example SQL code for creating ORDER-INVOICE relationship database view (e.g., database view 602) may be as follows:

### ORDER-INVOICE Calculated Relationship (e.g., Database View 602A)

create view d001707.vbfa_join_order_invoice as

-- Invoice, VBTYP = K, L, M, N, U, 5, 6

select vbap.vbeln as vbeln_v

,vbap.posnr as posnr_v
,vbak.vbtyp as vbtyp_v
,vbrp.vbeln as vbeln_n
,vbrp.posnr as posnr_n
,vbrk.vbtyp as vbtyp_n

| | |
|---|---|
| -- | calculation similar to VBFA_FUELLEN(LV60AA99) |

,(case

when vbrp.shkzg = ‘A’ or vbrp.shkzg = ‘B’ then

( vbrp.fkimg * −1)

| | else vbrp.fkimg |
|---|---|
| end) | as RFMNG |
| ,vbrp.meins | as MEINS |

| | |
|---|---|
| -- | calculation similar to VBFA_FUELLEN(LV60AA99) |

| | |
|---|---|
| ,vbrp.netwr | as RFWRT_ORIG |

,(case

when vbrk.waerk = vbrk.stwae then vbrp.netwr
else

| | |
|---|---|
| -- | currency Währungsumrechnung notwendig |
| convert_currency(amount=>vbrp.netwr, | |

“SOURCE_UNIT_COLUMN” =>vbrk.waerk,

“TAR-

GET_UNIT_COLUMN” =>vbrk.stwae,

“SCHEMA” =>

‘SAPCCH’,

“REFER-

ENCE_DATE_COLUMN” =>vbrp.kursk_dat,

“ACCURACY”

=>‘compatibility’,

“STEPS”=>‘shift,convert,round’,

“ER-

ROR_HANDLING” =>‘set to null’,

“CLIENT” =>‘321’ )

| | |
|---|---|
| end) | as RFWRT |

| | |
|---|---|
| ,vbrk.stwae | as WAERS |

| | |
|---|---|
| -- | Attention: only first matching branch is executed |

,(case

when tvcpf_1.mandt <> ″ then tvcpf_1.plmin

| when tvcpf_2.mandt <> ″ then tvcpf_2.plmin | |
|---|---|
| else ‘x’ | |
| end) | as PLMIN |

| | |
|---|---|
| ,″ | as TAQUI |

| | |
|---|---|
| ,vbrp.erdat | as ERDAT |
| ,vbrp.erzet | as ERZET |

| | |
|---|---|
| ,″ | as MATNR |
| ,″ | as BWART |
| ,″ | as BDART |
| ,″ | as PLART |

| | |
|---|---|
| ,‘00’ | as STUFE |

| | |
|---|---|
| ,″ | as LGNUM |

| | |
|---|---|
| ,‘00000000’ | as AEDAT |

| | |
|---|---|
| -- | calculation similar to VBFA_FUELLEN(LV60AA99) |

,(case vbrk.fktyp

| | |
|---|---|
| when ‘L’ | then ‘A’ |

| else vbrk.fktyp | |
|---|---|
| end) | as FKTYP |

| | |
|---|---|
| ,0 | as BRGEW |
| ,″ | as GEWEI |
| ,0 | as VOLUM |
| ,″ | as VOLEH |

| | |
|---|---|
| ,vbrp.fplnr | as FPLNR |

,vbrp.fpltr as FPLTR

| | |
|---|---|
| -- | calculation similar to VBFA_FUELLEN(LV60AA99) |

,(case

when vbrp.shkzg = ‘A’ or vbrp.shkzg = ‘B’ then

( vbrp.fkimg * vbrp.umvkz / vbrp.umvkn * −1)

else ( vbrp.fkimg * vbrp.umvkz / vbrp.umvkn )

| | |
|---|---|
| end) | as RFMNG_FLO |

| | |
|---|---|
| -- | calculation similar to VBFA_FUELLEN(LV60AA99) |

,(case

when vbrp.shkzg = ‘A’ or vbrp.shkzg = ‘B’ then

( vbrp.fkimg * −1)

else vbrp.fkimg

| end) | as RFMNG_FLT |
|---|---|
| ,vbap.vrkme as VRKME | |
| ,0 | as ABGES |
| ,″ | as SOBKZ |
| ,″ | as SONUM |
| ,″ | as KZBEF |
| ,0 | as NTGEW |
| ,″ | as LOGSYS |
| ,″ | as WBSTA |
| ,″ | as CMETH |
| ,‘0000’ | as MJAHR |
| ,″ | as VBTYPEXT_V |
| ,″ | as VBTYPEXT_N |

from sapcch.vbap as vbap

| join sapcch.vbak as vbak | |
|---|---|
| on vbak.mandt = vbap.mandt | |
| and vbak.vbeln = vbap.vbeln | |
| join sapcch.vbrp as vbrp | |
| on vbrp.mandt = vbap.mandt | |
| and vbrp.vgbel = vbap.vbeln | |
| and vbrp.vgpos | = vbap.posnr |

join sapcch.vbrk as vbrk
on vbrk.mandt = vbrp.mandt
and vbrk.vbeln = vbrp.vbeln

-- Prio-1 copy control depending on VBAP Positionstyp

left outer join sapcch.tvcpf as tvcpf_1
on tvcpf_1.mandt = vbrk.mandt
and tvcpf_1.auarv = vbak.auart
and tvcpf_1.fkarn = vbrk.fkart
and tvcpf_1.pstyv = vbap.pstyv

-- Prio-2 copy control not depending on VBAP Positionstyp

left outer join sapcch.tvcpf as tvcpf_2
on tvcpf_2.mandt = vbrk.mandt
and tvcpf_2.auarv = vbak.auart
and tvcpf_2.fkarn = vbrk.fkart
and tvcpf_2.pstyv = ″

```
where vbap.mandt = ‘321’
  and vbak.vbtyp in ( ‘C’, ‘H’,‘I’ )
  and vbrk.vbtyp in (‘K’, ‘L’, ‘M’, ‘N’, ‘U’, ‘5’, ‘6’ );
```

### ORDER-INVOICE Including Exceptions (e.g., Database View Exception 602B)

create view d001707.vbfa_join_order_invoice_except as

| | |
|---|---|
| select vbfa_dyna.vbeln_v | as |

vbeln_v,

| | |
|---|---|
| vbfa_dyna.posnr_v | as |

posnr_v,

| | |
|---|---|
| vbfa_dyna.vbtyp_v | as |

vbtyp_v,

| | |
|---|---|
| vbfa_dyna.vbeln_n | as |

vbeln_n,

| | |
|---|---|
| vbfa_dyna.posnr_n | as |

posnr_n,

| | |
|---|---|
| vbfa_dyna.vbtyp_n | as |

vbtyp_n,

| coalesce (vbfa_except.rfmng, vbfa_dyna.rfmng ) as rfmng, | |
|---|---|
| coalesce (vbfa_except.meins, vbfa_dyna.meins ) as meins, | |
| vbfa_dyna.rfwrt_orig | as rfwrt_orig, |

| coalesce (vbfa_except.rfwrt, vbfa_dyna.rfwrt ) as rfwrt, | |
|---|---|
| coalesce (vbfa_except.waers, vbfa_dyna.waers ) as waers, | |
| coalesce (vbfa_except.plmin, vbfa_dyna.plmin ) as plmin, | |
| coalesce (vbfa_except.taqui, vbfa_dyna.taqui ) as taqui, | |
| coalesce (vbfa_except.erdat, vbfa_dyna.erdat ) as erdat, | |
| coalesce (vbfa_except.erzet, vbfa_dyna.erzet ) as erzet, | |
| coalesce (vbfa_except.matnr, vbfa_dyna.matnr ) as matnr, | |
| coalesce (vbfa_except.bwart, vbfa_dyna.bwart ) as bwart, | |
| coalesce (vbfa_except.bdart, vbfa_dyna.bdart ) as bdart, | |
| coalesce (vbfa_except.plart, vbfa_dyna.plart ) as plart, | |
| vbfa_dyna.stufe | as |

stufe,

| coalesce (vbfa_except.lgnum, vbfa_dyna.lgnum ) as lgnum, | |
|---|---|
| coalesce (vbfa_except.aedat, vbfa_dyna.aedat ) as aedat, | |
| coalesce (vbfa_except.fktyp, vbfa_dyna.fktyp ) as fktyp, | |
| coalesce (vbfa_except.brgew, vbfa_dyna.brgew ) as brgew, | |
| coalesce (vbfa_except.gewei, vbfa_dyna.gewei ) as gewei, | |
| coalesce (vbfa_except.volum, vbfa_dyna.volum ) as volum, | |
| coalesce (vbfa_except.voleh, vbfa_dyna.voleh ) as voleh, | |
| coalesce (vbfa_except.fplnr, vbfa_dyna.fplnr ) as fplnr, | |
| coalesce (vbfa_except.fpltr, vbfa_dyna.fpltr ) as fpltr, | |
| coalesce (vbfa_except.rfmng_flo, vbfa_dyna.rfmng_flo ) as | |
| rfmng_flo, | |
| coalesce (vbfa_except.rfmng_flt, vbfa_dyna.rfmng_flt ) as | |
| rfmng_flt, | |
| coalesce (vbfa_except.vrkme, vbfa_dyna.vrkme ) as vrkme, | |
| coalesce (vbfa_except.abges, vbfa_dyna.abges ) as abges, | |
| coalesce (vbfa_except.sobkz, vbfa_dyna.sobkz ) as sobkz, | |
| coalesce (vbfa_except.sonum, vbfa_dyna.sonum ) as sonum, | |
| coalesce (vbfa_except.kzbef, vbfa_dyna.kzbef ) as kzbef, | |
| coalesce (vbfa_except.ntgew, vbfa_dyna.ntgew ) as ntgew, | |
| coalesce (vbfa_except.logsys, vbfa_dyna.logsys ) as logsyst, | |
| coalesce (vbfa_except.wbsta, vbfa_dyna.wbsta ) as wbsta, | |
| coalesce (vbfa_except.cmeth, vbfa_dyna.cmeth ) as cmeth, | |
| coalesce (vbfa_except.mjahr, vbfa_dyna.mjahr ) as mjahr, | |
| vbfa_dyna.vbtypext_v | as vbtypext_v, |
| vbfa_dyna.vbtypext_n | as vbtypext_n |

| | |
|---|---|
| from | d001707.vbfa_join_order_invoice as vbfa_dyna |

left outer join d001707.zrwe_vbfa_except
as vbfa_except

```
  on vbfa_dyna.vbeln_v = vbfa_except.vbeln_v
  and vbfa_dyna.posnr_v = vbfa_except.posnr_v
  and vbfa_dyna.vbtyp_v = vbfa_except.vbtyp_v
  and vbfa_dyna.vbeln_n = vbfa_except.vbeln_n
  and vbfa_dyna.posnr_n = vbfa_except.posnr_n
  and vbfa_dyna.vbtyp_n = vbfa_except.vbtyp_n
```

Example SQL code for creating an ORDER-DELIVERY relationship database view and a DELIVERY-INVOICE relationship database view (e.g., database view 604) may be similar to the foregoing example code for creating the ORDER-INVOICE relationship database view (e.g., database view 602).

In an example implementation, “remaining persistently stored relationships” view 606 may, for example, include persistently stored relationships (Delivery→WMF transfer order and Goods Movement). An example SQL code for creating “remaining persistently stored relationships” view 606 (Delivery→WMF transfer order and Goods Movement) may be as follows:
create view d001707.zrwe_vbfa_except_delivery_goods movement as

| | | | |
|---|---|---|---|
| select | vbelv | as | vbeln_v, |
| | posnv | as | posnr_v, |
| | vbtyp_v | as | vbtyp_v, |
| | vbeln | as | vbeln_n, |
| | posnn | as | posnr_n, |
| | vbtyp_n | as | vbtyp_n, |

| | | |
|---|---|---|
| rfmng | as | rfmng, |
| meins | as | meins, |

| cast ( 0 as dec (15,2)) as rfwrt_orig, | | |
|---|---|---|
| rfwrt | as | rfwrt, |
| waers | as | waers, |
| plmin | as | plmin, |
| taqui | as | taqui, |
| erdat | as | erdat, |
| erzet | as | erzet, |

| | | |
|---|---|---|
| matnr | as | matnr, |
| bwart | as | bwart, |
| bdart | as | bdart, |
| plart | as | plart, |
| stufe | as | stufe, |
| lgnum | as | lgnum, |
| aedat | as | aedat, |
| fktyp | as | fktyp, |
| brgew | as | brgew, |
| gewei | as | gewei, |
| volum | as | volum, |
| voleh | as | voleh, |
| fplnr | as | fplnr, |
| fpltr | as | fpltr, |

| | | |
|---|---|---|
| rfmng_flo | as | rfmng_flo, |
| rfmng_flt | as | rfmng_flt, |

| | | |
|---|---|---|
| vrkme | as | vrkme, |
| abges | as | abges, |
| sobkz | as | sobkz, |
| sonum | as | sonum, |
| kzbef | as | kzbef, |
| ntgew | as | ntgew, |
| logsys | as | logsys, |
| wbsta | as | wbsta, |
| cmeth | as | cmeth, |
| mjahr | as | mjahr, |

vbtypext_v as vbtypext_v,
vbtypext_n as vbtypext_n

| | |
|---|---|
| from | sapcch.vbfa |
| where | mandt = ‘321’ |

and stufe = ‘00’
and ( ( vbtyp_v = ‘J’ and vbtyp_n =‘Q’ ) or

( vbtyp_v = ‘J’ and vbtyp_n =‘R’ ) );

Further, an example SQL code for joining the distinct calculated and persistently stored relationships database views (e.g., database view 602, database view 604 and database view 606, etc.) to create the final database view 600 may be as follows:

create view d001707.zrwe_vbfa_virtual_except as
select * from d001707.vbfa_join_order_invoice_except union all
select * from d001707.vbfa_join_order_delivery_except union all
select * from d001707.vbfa_join_delivery_invoice_except union all
select * from d001707.zrwe_vbfa_except_delivery_goods_movement;

### Test Implementations of Database Views of Document Flow

Implementations view-based representation of the document flow (e.g., database view 600) (similar to that described above) were tested on a computer system, which included a HANA platform coupled to a sales documents (SD) database (table VBFA) having about 250 million rows of data. Table VBFA included about 180 million rows of direct document-document relationship data.

Tests were conducted to determine execution time differences between obtaining view-based representation of document flow (e.g., database view 600) and obtaining document flow by retrieving document-document relationships directly from table VBFA.

In obtaining view-based representation of document flow (e.g., database view 600), document relations for group Order-Invoice, Order-Delivery, and Delivery-Order were calculated on the fly. Further, document relations for Delivery-WMG transfer and Goods Movement were directly retrieved from persistent data table VBFA.

The number of rows calculated on the fly were as follows: Order-Invoice˜670.00 rows (+˜100 rows of exceptions); Order-Delivery˜21 m rows (+˜1000 rows of exceptions); and Delivery-Invoice˜37 m rows (+˜20 m rows exceptions). The number of document relationships for Delivery-WMG transfer and goods movement, which were directly retrieved from persistent data was about 80 m rows.

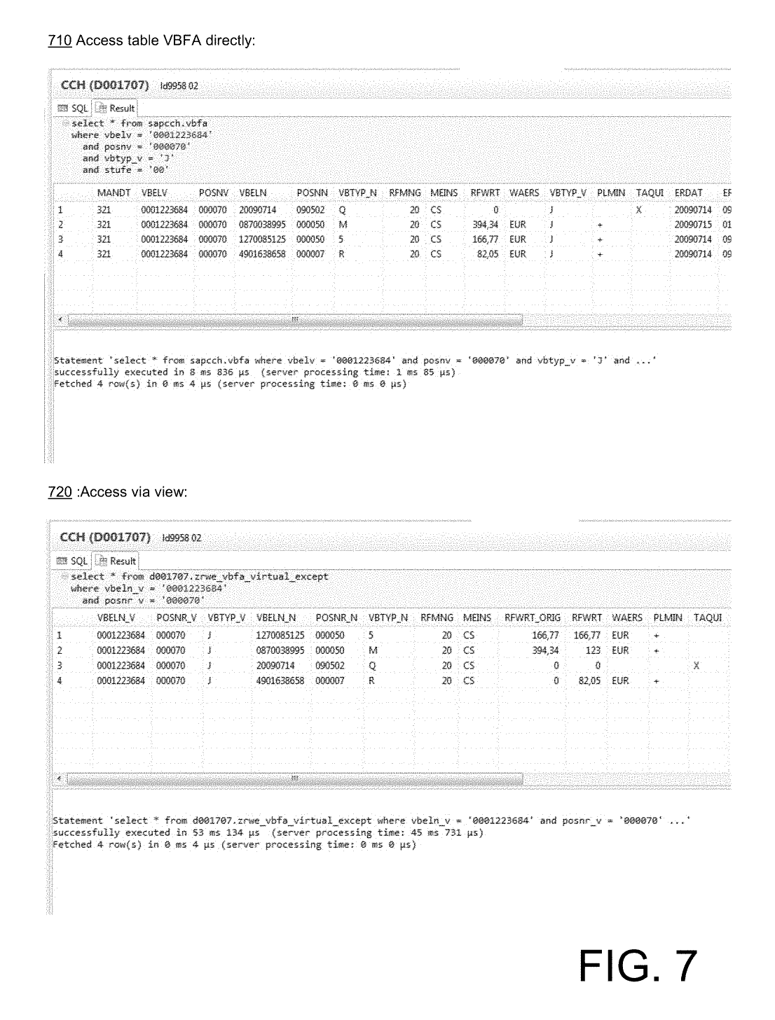

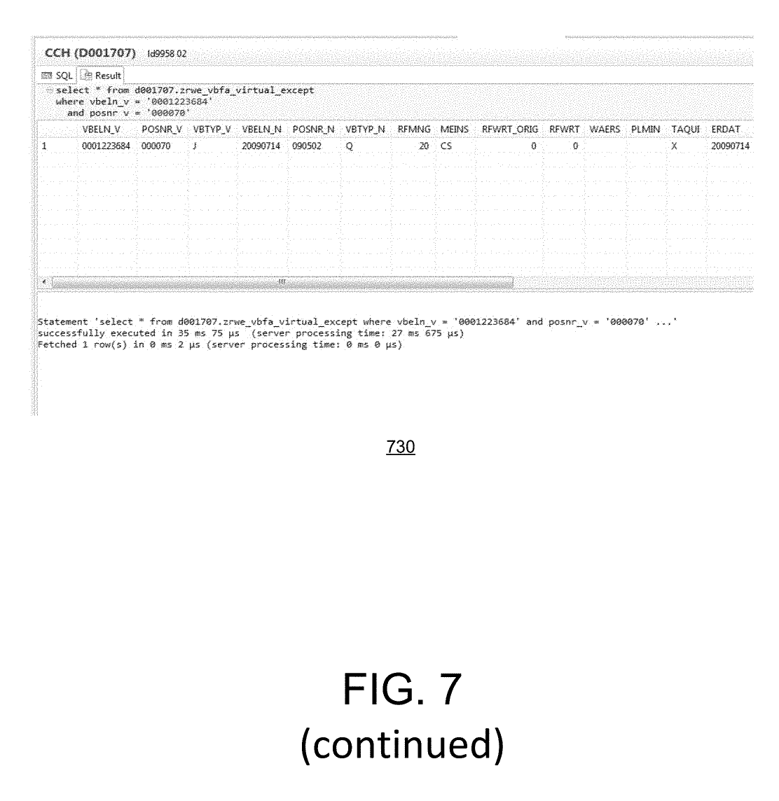

A first test involved determining the execution times for returning invoices and WMF-transfer orders related to delivery (1) when accessing table VBFA directly to retrieve document-document relationships, and (2) when accessing the document-document relationships via a database view (“View”). FIG. 7 shows, for example, illustrative screenshots 710, 720 and 730 of the test measurements. Execution of the select statements to fetch the four rows of data by accessing table VBFA directly took about 8.836 ms (with a server processing time of about 1.85 ms). Execution of the select statement to fetch the four rows of data via View took about 53.134 ms (with a server processing time of about 45.731 ms). The longer time to fetch the four rows of data via View was expected as access via view involves execution of join and union operations. However, it is noted that a server processing time of about 45 ms is well below a human perception threshold, for example, when the results are displayed on a computer screen to a human user.

In the first test, it was also determined that the currency conversion operations (as shown in screenshot 730) were a big contributor to the overall run-time. Checking the run-time for only accessing WMF-transfer-orders yielded significantly lower processing time numbers (e.g., about 27.675 ms as shown in screenshot 730).

A second test involved determining the execution times for returning deliveries related to orders (1) when accessing table VBFA directly to retrieve document-document relationships, and (2) when accessing the document-document relationships via a database view. Execution of the select statements to fetch the four rows of data by accessing table VBFA directly took about 8.639 ms (with a server processing time of about 1.33 ms). Execution of the select statement to fetch the four rows of data via View took about 34.638 ms (with a server processing time of about 27 ms). The longer time to fetch the four rows of data via View was expected as access via view involves a number of join operations. The join operations required an access plan to be calculated and separate, distinct tables to be accessed, which added to the total run-time. However, it is noted that a server processing time of about 27 ms is still well below a perceivable threshold.

It was also determined that the currency conversion operations were a big contributor to the overall run-time. The run-time for accessing view without currency conversion was significantly lower (about 42.210 ms) as shown in screenshot 830. Even without currency conversion, the database view (e.g., database view 600) may still be expected to include the same document flow as with currency conversion because an exception exists for the relationship overriding the calculated values. The document-documents relationships requiring currency conversion (but not calculated) would be included in the exceptions (e.g., exceptions 604B) included in database view 600.

These tests demonstrated that SQL level computing power consumption for calculating or determining document flow as a database view is comparable to that for retrieving document flow records from persistent memory (e.g. table VBFA). However, using database views to calculate or determine document flow may obviate or reduce the need to store document flow records in memory. In an example implementation, a total memory allocation for direct document relationships may be about ˜26 GB (for ˜180 m rows). A total memory allocation for the on-the-fly calculated relationships (assuming no exceptions) used to construct the database view may be only about ˜9 GB (for ˜58 m rows) i.e. about 17 GB less total memory allocation for direct document relationships. For a system in which a total memory allocation for sales document tables is ˜140 GB, the memory allocation for the on-the-fly calculated relationships represents a saving of about 6-7%.

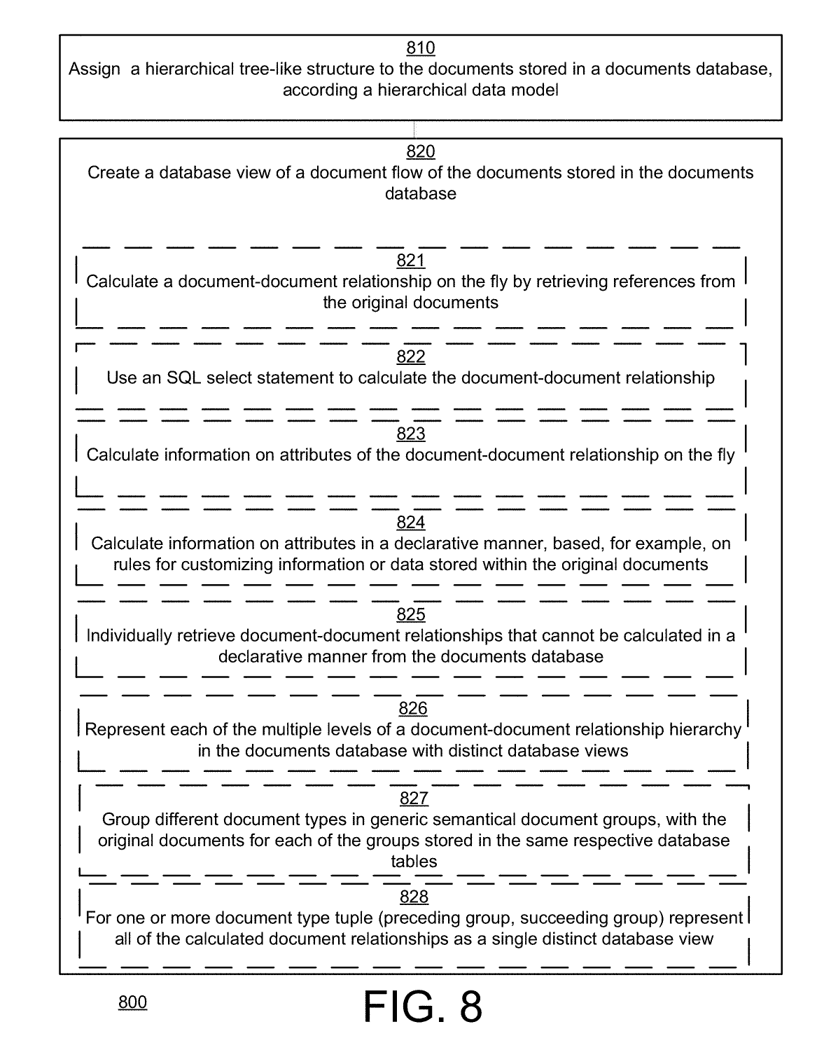

FIG. 8 shows an example computer-implemented method 800 for determining a document flow of documents (e.g., business transactions documents) stored in a documents database, in accordance with the principles of the present disclosure. Data on the documents (including relational data) may be stored in the documents database and also possibly in a table (e.g., table 322, table VBFA, etc.).

Method 800 may include assigning a hierarchical tree-like structure to original documents stored in the documents database, according to a hierarchical data model (810). The hierarchical tree-like structure may include one or more hierarchy levels beginning with a document assigned to a root node of the tree-like structure. Each hierarchy level in the tree-like structure may correspond to a direct document-document relationship between the documents assigned to the tree nodes of the hierarchy level.

Method 800 may further include creating a database view of a document flow of the documents stored in the documents database (820). Creating the database view of the document flow may include calculating a document-document relationship on the fly by retrieving references from the original documents (821).

In an example implementation, calculating a document-document relationship on the fly 822 may include using an SQL select statement to calculate the document-document relationship (822).

An example database view of the document flow, as described herein, in addition to predecessor and successor information for documents may include a number of additional attributes for various business related information. Creating the database view of the document flow 820 may also include calculating information on attributes of the document-document relationship on the fly (823). Calculating information on attributes of the document-document relationship on the fly includes calculating information on attributes in a declarative manner, based, for example, on rules for customizing information or data stored within the original documents (824).

In specific instances, there may be exceptions to the rules for customizing information or data stored within the original documents, which may preclude calculation of some data or information in a declarative manner. In such instances, creating a database view of a document flow of the documents stored in the documents database 820 may include individually retrieving document-document relationships that cannot be calculated in a declarative manner from the documents database (825).

In an illustrative example, the documents may include a large number of different document types. Each document having a specific document type may be related to another document of another document type. In method 800, creating a database view of the document flow of the documents stored in the documents database 820 may include representing each of the multiple levels of a document-document relationship hierarchy in the documents database with distinct database views (826). Creating a database view of the document flow may include grouping different document types in generic semantical document groups, with the original documents for each of the groups stored in the same respective database tables (827). For each document type tuple (preceding group, succeeding group), the same attributes may be used as a reference to calculate or establish the relationship or link between any two documents in the tuple.

Further, creating the database view of the document flow 820 may include, for one or more document type tuple (preceding group, succeeding group) representing all of the calculated document relationships as a single distinct database view (828). Method 800 may further include, for all document type tuples for which the document relationships are not calculated, supplementing the calculated relationships represented in the single database view with a database table storing the uncalculated document relationships

The various systems and techniques described herein may be implemented in digital electronic circuitry, or in computer hardware, firmware, or in combinations of them. The various techniques (e.g., method 800) may implemented via a computer program product, i.e., a computer program with instructions tangibly embodied in a machine readable storage device, for execution by, or to control the operation of, data processing apparatus, e.g., a programmable processor, a computer, or multiple computers.

Method steps may be performed by one or more programmable processors executing a computer program to perform functions by operating on input data and generating output. Method steps also may be performed by, and an apparatus may be implemented as, logic circuitry or special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of nonvolatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a backend component, e.g., as a data server, or that includes a middleware component, e.g., an application server, or that includes a frontend component, e.g., a client computer having a graphical user interface or a Web browser through which a user can interact with an implementation, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for determining a document flow of documents stored in a documents database, the method comprising:
assigning a hierarchical tree-like structure to the documents stored in the documents database, each hierarchy level in the tree-like structure corresponding to a direct document-document relationship between the documents assigned to the nodes of the hierarchy level; and
creating a database view of a document flow of the documents stored in the documents database.

2. The computer-implemented method of claim 1, wherein creating the database view of the document flow includes calculating a document-document relationship on the fly by retrieving references from the original documents.

3. The computer-implemented method of claim 2, wherein calculating the document-document relationship on the fly includes using an SQL select statement to calculate the document-document relationship.

4. The computer-implemented method of claim 2, wherein the database view of the document flow, in addition to predecessor and successor information for documents includes information for a number of additional attributes of the document-document relationship, and wherein creating the database view of the document flow includes calculating information on attributes of the document-document relationship on the fly.

5. The computer-implemented method of claim 4, wherein calculating information on attributes of the document-document relationship on the fly includes calculating information on attributes in a declarative manner based on rules for customizing information or data stored within the original documents.

6. The computer-implemented method of claim 1, wherein creating the database view of the document flow includes individually retrieving document-document relationships that cannot be calculated in a declarative manner from the documents database.

7. The computer-implemented method of claim 1, wherein creating the database view of the document flow includes representing each of multiple levels of a document-document relationship hierarchy in the documents database with distinct database views.

8. The computer-implemented method of claim 1, wherein creating the database view of the document flow includes grouping different document types in generic semantical document groups, and, for each document type tuple (preceding group, succeeding group), using a same set of attributes as a reference to calculate a relationship between any two documents in the tuple.

9. The computer-implemented method of claim 8, wherein creating the database view of the document flow includes, for one or more document type tuple (preceding group, succeeding group) representing all of the calculated document relationships as a single distinct database view.

10. The computer-implemented method of claim 9, wherein creating the database view of the document flow includes, for all document type tuples for which the document relationships are not calculated, supplementing the calculated relationships represented in the single database view with a database table storing the uncalculated document relationships.

11. A computer system for determining a document flow of documents, data on the documents being stored in a documents database, the computer system comprising a memory and a semiconductor-based processor, the memory and the processor forming one or more logic circuits configured to:
query the documents stored in the documents database; and
create a database view of a document flow of the documents stored in the documents database.

12. The computer system of claim 11, wherein the database view of the document flow of the documents includes distinct database views for one or more different document type groups.

13. The computer system of claim 12, wherein each database view for a document type group includes calculated document-document relationships which are calculated using open SQL queries.

14. The computer system of claim 13, wherein each database view for a document type group in addition to calculated document-document relationships which are calculated using open SQL queries includes document-document relationships that are exceptions to calculated values.

15. The computer system of claim 12, wherein the database view of the document flow of the documents in addition to distinct database views for the one or more different document type groups includes persistent document relationships which are not calculated from references in the documents but are persistently stored in a database table.

16. A non-transitory computer readable storage medium having instructions stored thereon, including instructions which, when executed by a microprocessor, cause a computer system to:
query documents stored in a documents database; and
create a database view of a document flow of the documents stored in the documents database.

17. The non-transitory computer readable storage medium of claim 16, wherein the database view of the document flow of the documents includes distinct database views for one or more different document type groups.

18. The non-transitory computer readable storage medium of claim 17, wherein each database view for a document type group includes calculated document-document relationships which are calculated using open SQL queries.

19. The non-transitory computer readable storage medium of claim 18, wherein each database view for a document type group in addition to calculated document-document relationships which are calculated using open SQL queries includes document-document relationships that are exceptions to calculated values.

20. The non-transitory computer readable storage medium of claim 16, wherein the database view of the document flow of the documents in addition to distinct database views for the one or more different document type groups includes persistent document relationships which are not calculated from references in the documents but are persistently stored in a database table.
